(19) United States
(12) Patent Application Publication
(10) Pub. No.: US 2023/0156495 A1
(43) Pub. Date: May 18, 2023

(54) MOBILE TERMINAL TESTING SYSTEM AND PARAMETER SETTING METHOD THEREOF

(71) Applicant: ANRITSU CORPORATION, Kanagawa (JP)

(72) Inventors: Daiki KANO, Kanagawa (JP); Nobuaki SHIMAKAWA, Kanagawa (JP)

(21) Appl. No.: 18/049,038

(22) Filed: Oct. 24, 2022

(30) Foreign Application Priority Data
Nov. 18, 2021 (JP) 2021-187771

(51) Int. Cl. H04W 24/06; H04M 1/24

(52) U.S. Cl. CPC H04W 24/06; H04M 1/24

(57) ABSTRACT

A mobile terminal testing system includes a mobile terminal testing device 1 that includes an LTE measurement unit 12 which transmits and receives a signal to and from a mobile terminal by LTE and an NR measurement unit 13 which transmits and receives the signal to and from the mobile terminal by NR, and a personal computer device 2 that includes an LTE interface unit 22 which controls an interface with a user for LTE and an NR interface unit 23 which controls an interface with the user for NR, in which the LTE interface unit 22 acquires a hardware configuration of the LTE measurement unit 12, and converts and sets a parameter set in the interface with a user into a parameter suitable for the hardware configuration of the LTE measurement unit 12.

### TECHNICAL FIELD

The present invention relates to a mobile terminal testing system for testing a mobile terminal.

### BACKGROUND ART

When a mobile terminal for performing communication while moving, such as a mobile phone or a data communication terminal, is developed, the developed mobile terminal needs to be tested whether or not communication can be normally performed. Therefore, a mobile terminal to be tested is connected to a testing device operated as a pseudo base station that simulates functions of an actual base station to perform communication between the testing device and the mobile terminal, and a test to confirm contents of the communication is performed.

Moreover, in the mobile communication system, a 5th generation (5G) new radio (NR) service, which is a 5G wireless system, has started.

In 5G NR, a 5G line is specialized for user plane (U-Plane: user data signal), and control plane (C-Plane: communication control signal) defines specifications for non-standalone (NSA) that transmits and receives using a long term evolution (LTE) line and stand alone (SA) that operates independently in 5G NR without cooperation with LTE.

Patent Document 1 discloses a mobile terminal testing system for performing a test of NSA with a mobile terminal testing device operated as a base station of LTE and a mobile terminal testing device operated as a base station of NR.

### RELATED ART DOCUMENT

### Patent Document

[Patent Document 1] JP-A-2020-088558

### DISCLOSURE OF THE INVENTION

### Problem that the Invention is to Solve

In such a mobile terminal testing system, when the mobile terminal compatible with NSA is tested, the configuration of the testing system becomes large because the mobile terminal testing device operated as the base station of LTE and the mobile terminal testing device operated as the base station of NR are used.

It is conceivable to reduce a size by integrating the mobile terminal testing device that operates as an LTE base station and the mobile terminal testing device that operates as an NR base station.

In such a case, the hardware configuration may change, and the set values of the hardware may also change. Accordingly, when set values in an interface with a user also change, the user needs to change the set values to new set values, and the existing setting information cannot be used, resulting in an increase of an operation of switching devices.

The present invention is to provide a mobile terminal testing system capable of reducing the operation of switching devices even if the hardware configuration changes.

### Means for Solving the Problem

A mobile terminal testing system of the present invention is a mobile terminal testing system including a mobile terminal testing device that tests the mobile terminal by simulating a mobile communication base station, and an external device that executes a test by controlling the mobile terminal testing device, in which the external device includes an interface unit that controls an interface with a user for a predetermined communication standard, the mobile terminal testing device includes a measurement unit that transmits and receives a signal to and from the mobile terminal according to the predetermined communication standard, and the interface unit acquires a hardware configuration of the measurement unit, and converts and sets a parameter set in the interface with the user into a parameter suitable for the hardware configuration of the measurement unit.

With this configuration, the hardware configuration of the measurement unit is acquired, and the parameter set in the interface with the user is converted and set into the parameter suitable for the hardware configuration of the measurement unit. Therefore, even if the hardware configuration changes, a test without changing the parameter in the interface with the user can be set, and an operation of switching devices can be reduced.

In the mobile terminal testing system of the present invention, the measurement unit includes a signal generation unit that generates a predetermined signal, and the interface unit converts and sets the parameter set in the interface with the user into the parameter suitable for the hardware configuration of the measurement unit, according to a parameter setting method of the signal generation unit.

With this configuration, the parameter set in the interface with the user is converted and set according to the parameter setting method of the signal generation unit. Therefore, even if the hardware configuration of the signal generation unit changes, the signal generation unit can be set without changing the parameter in the interface with the user, and an amount of operation of switching devices can be reduced.

In the mobile terminal testing system of the present invention, the signal generation unit enables generation of a signal for a plurality of frequencies, the parameter set in the interface with the user is a center frequency of the plurality of frequencies, and the parameter suitable for the hardware configuration of the measurement unit is the plurality of frequencies.

A parameter setting method of the present invention is a parameter setting method of a mobile terminal testing system, in which the mobile terminal testing system includes a mobile terminal testing device that includes a measurement unit which transmits and receives a signal to and from a mobile terminal according to a predetermined communication standard to test the mobile terminal by simulating a mobile communication base station, and an external device that includes an interface unit which controls an interface with a user for the predetermined communication standard to execute a test by controlling the mobile terminal testing device, the parameter setting method includes: a step of acquiring a hardware configuration of the measurement unit; and a step of converting and setting a parameter set in the interface with the user into a parameter suitable for the hardware configuration of the measurement unit.

With this configuration, the hardware configuration of the measurement unit is acquired, and the parameter set in the interface with the user is converted and set into the parameter suitable for the hardware configuration of the measurement unit. Therefore, even if the hardware configuration changes, a test without changing the parameter in the interface with the user can be set, and an effort for switching devices can be reduced.

### Advantage of the Invention

The present invention can provide a mobile terminal testing system capable of reducing the operation of switching the device even if the hardware configuration changes.

### BRIEF DESCRIPTION OF THE DRAWINGS

FIG. 1 is a block diagram of a mobile terminal testing system according to an embodiment of the present invention.

FIG. 2 is a diagram showing a configuration example of an LTE measurement unit of the mobile terminal testing system according to an embodiment of the present invention.

FIGS. 3A to 3C are diagrams showing an example of parameters of the mobile terminal testing system according to an embodiment of the present invention, in which FIG. 3A is a diagram showing a setting example of parameters in an interface with a user, FIG. 3B is a diagram showing an allocation example of an antenna signal and a port, and FIG. 3C is a diagram showing a setting example of parameters to hardware.

### BEST MODE FOR CARRYING OUT THE INVENTION

Hereinafter, a mobile terminal testing system according to an embodiment of the present invention will be described in detail with reference to the drawings.

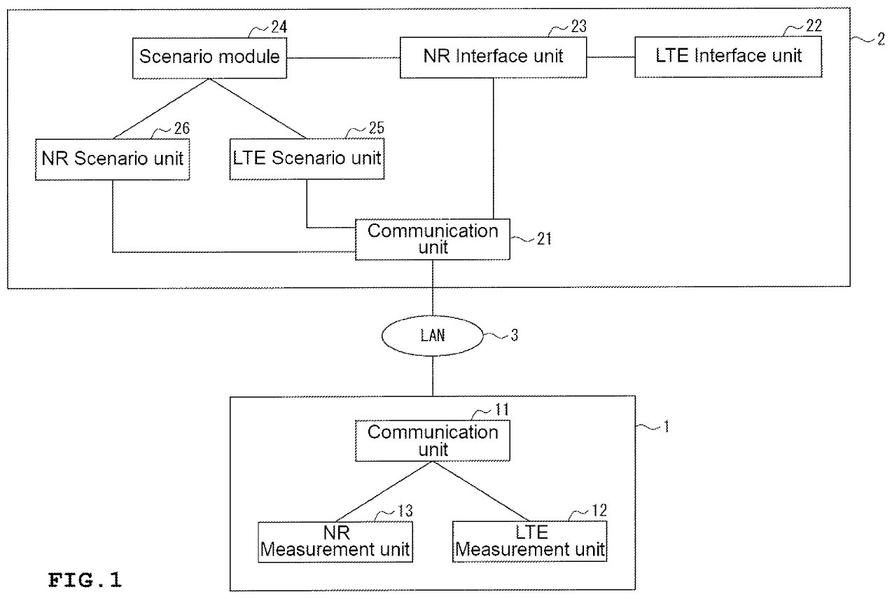

In FIG. 1, a mobile terminal testing system according to an embodiment of the present invention includes a mobile terminal testing device 1 and a personal computer device (hereinafter simply referred to as “PC”) 2 as an external device.

The mobile terminal testing device 1 is controlled by the PC 2 to test mobile terminals.

The mobile terminal testing device 1 is composed of a computer unit that includes a central processing unit (CPU), a random access memory (RAM), a read only memory (ROM), a flash memory, a hard disk device, an input port, and an output port.

In the computer unit, the CPU executes an operating system (OS) stored in the hard disk device, such that the CPU can control a device connected to the input port and the output port.

The mobile terminal testing device 1 includes a communication unit 11, an LTE measurement unit 12 and an NR measurement unit 13.

The communication unit 11 is composed of a communication module. The communication unit 11 communicates with a PC 2 via a local area network (LAN) 3 conforming to the Ethernet (registered trademark) connected to the input and output port.

The LTE measurement unit 12 transmits and receives a radio frequency (RF) signal of LTE to and from the mobile terminal. The LTE measurement unit 12 measures the RF signal received from the mobile terminal. The LTE measurement unit 12 transmits, to the PC 2, information of the measured result of the RF signal received from the mobile terminal.

The NR measurement unit 13 transmits and receives a radio frequency (RF) signal of NR to and from the mobile terminal. The NR measurement unit 13 measures the RF signal received from the mobile terminal. The NR measurement unit 13 transmits, to the PC 2, information of a measured result of the RF signal received from the mobile terminal.

The PC 2 is composed of a computer unit that includes the CPU, the RAM, the ROM, the flash memory, the hard disk device, the input port, the output port, a display unit, and an operation unit.

The display unit is composed of an image display device such as a liquid crystal display, and displays an image for inputting information necessary for setting the test, an image showing a state during the test, and the like.

The operation unit is composed of input devices such as a keyboard, a mouse, and a touch panel, and outputs information and the like input by an operation to the CPU.

In the computer unit, the CPU executes the OS stored in the hard disk device, such that the CPU can control a device connected to the input port and the output port.

The PC 2 includes a communication unit 21, an LTE interface unit 22, an NR interface unit 23, a scenario module 24, an LTE scenario unit 25, and an NR scenario unit 26.

The communication unit 21 is composed of a communication module. The communication unit 21 communicates with the mobile terminal testing device 1 via the Ethernet (registered trademark) conforming to the LAN 3 connected to the input and output port.

The LTE interface unit 22 controls an interface that allows a user to make settings related to LTE for the test and control execution of the test. The LTE interface unit 22 displays, on the display unit, a setting screen of a pseudo base station or a setting screen of a test procedure that is used in the test to create a scenario for LTE of the test or control the execution of the test, according to the operation input to the operation unit.

The LTE interface unit 22 transmits information on the set scenario to the LTE scenario unit 25 via the NR interface unit 23, and the scenario module 24.

The LTE interface unit 22 transmits and receives the set setting information of the pseudo base station or control information such as start of the measurement of the received signal or the like to and from the LTE measurement unit 12 of the mobile terminal testing device 1 via the NR interface unit 23 and the communication unit 21.

The LTE measurement unit 12 of the mobile terminal testing device 1 sets a base station simulated based on the setting information of the pseudo base station transmitted from the LTE interface unit 22 of the PC 2. For example, the LTE measurement unit 12 measures the received signal based on the control information transmitted from the LTE interface unit 22 of the PC 2, and transmits the measured result to the PC 2 via the communication unit 11.

The NR interface unit 23 controls an interface that allows a user to make settings related to NR for the test and control execution of the test. The NR interface unit 23 displays, on the display unit, a setting screen of a pseudo base station or a setting screen of a test procedure that is used in the test to create an LTE scenario for NR of the test or control the execution of the test, according to the operation input to the operation unit.

The NR interface unit 23 transmits information on the set scenario to the NR scenario unit 26 via the scenario module 24.

The NR interface unit 23 transmits the set setting information of the pseudo base station or control information such as start of the measurement of the received signal or the like to the NR measurement unit 13 of the mobile terminal testing device 1 via the communication unit 21.

The NR measurement unit 13 of the mobile terminal testing device 1 sets a base station simulated based on the setting information of the pseudo base station transmitted from the NR interface unit 23 of the PC 2. For example, the NR measurement unit 13 measures the received signal based on the control information transmitted from the NR interface unit 23 of the PC 2, and transmits the measured result to the PC 2 via the communication unit 11.

The scenario module 24 distributes information on the scenario transmitted from the LTE interface unit 22 and the NR interface unit 23 to the LTE scenario unit 25 or the NR scenario unit 26.

The LTE scenario unit 25 transmits information to the LTE measurement unit 12 of the mobile terminal testing device 1 via the communication unit 21 in order to execute each procedure of the test according to the scenario for LTE, in response to an instruction from the LTE interface unit 22, and controls the LTE measurement unit 12.

The NR scenario unit 26 transmits information to the NR measurement unit 13 of the mobile terminal testing device 1 via the communication unit 21 in order to execute each procedure of the test according to the scenario for NR, in response to an instruction from the NR interface unit 23, and controls the NR measurement unit 13.

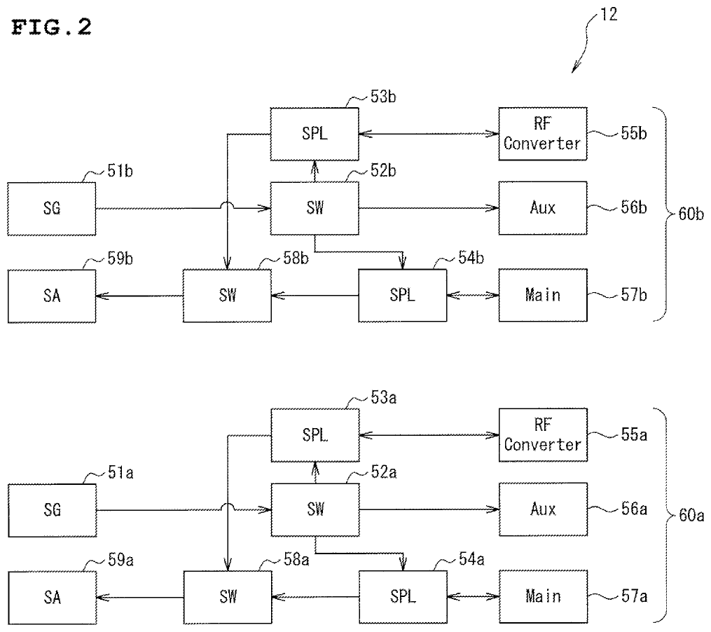

In the present embodiment, the LTE measurement unit 12 is configured as shown in FIG. 2. In FIG. 2, the LTE measurement unit 12 includes a first signal generation unit 51a, a switch 52a, a splitter 53a, a splitter 54a, an RF Converter terminal 55a, an Aux terminal 56a, a Main terminal 57a, a switch 58a, a first signal measurement unit 59a, a second signal generation unit 51b, a switch 52b, a splitter 53b, a splitter 54b, an RF Converter terminal 55b, an Aux terminal 56b, a Main terminal 57b, a switch 58b, and a second signal measurement unit 59b. The RF Converter terminal 55a, the Aux terminal 56a, and the Main terminal 57a constitute a first port 60a. The RF Converter terminal 55b, the Aux terminal 56b, and the Main terminal 57b constitute a second port 60b.

The first signal generation unit 51a generates a predetermined signal. The switch 52a outputs the signal generated by the first signal generation unit 51a to any one of the splitter 53a, the Aux terminal 56a, and the splitter 54a.

The splitter 53a outputs the signal input from the switch 52a to the switch 58a and the RF Converter terminal 55a, and outputs the signal input from the RF Converter terminal 55a to the switch 58a.

The splitter 54a outputs the signal input from the switch 52a to the switch 58a and the Main terminal 57a, and outputs the signal input from the Main terminal 57a to the switch 58a.

The RF Converter terminal 55a is connected to a mobile terminal by a cable so that the splitter 53a can input and output the signal to and from the mobile terminal.

The Aux terminal 56a is connected to the mobile terminal by a cable, so that the signal output from the switch 52a can be output to the mobile terminal.

The Main terminal 57a is connected to the mobile terminal by a cable, so that the splitter 54a can inputand output the signal to and from the mobile terminal.

The switch 58a outputs either the signal output from the splitter 53a or the signal output from the splitter 54a to the first signal measurement unit 59a.

The first signal measurement unit 59a measures a level of the signal input from the switch 58a.

The second signal generation unit 51b generates a predetermined signal. The switch 52b outputs the signal generated by the second signal generation unit 51b to any one of the splitter 53b, the Aux terminal 56b, and the splitter 54b.

The splitter 53b outputs the signal input from the switch 52b to the switch 58b and the RF Converter terminal 55b, and outputs the signal input from the RF Converter terminal 55b to the switch 58b.

The splitter 54b outputs the signal input from the switch 52b to the switch 58b and the main terminal 57b, and outputs the signal input from the Main terminal 57b to the switch 58b.

The RF Converter terminal 55b is connected to the mobile terminal by a cable so that the splitter 53b can input and output the signal to and from the mobile terminal.

The Aux terminal 56b is connected to the mobile terminal by a cable, so that the signal output from the switch 52b can be output to the mobile terminal.

The Main terminal 57b is connected to the mobile terminal by a cable, so that the splitter 54b can input and output the signal to and from the mobile terminal.

The switch 58b outputs either the signal output from the splitter 53b or the signal output from the splitter 54b to the second signal measurement unit 59b.

The second signal measurement unit 59b measures a level of the signal input from the switch 58b.

In the present embodiment, the LTE interface unit 22 sets a frequency of a component carrier (hereinafter also referred to as CC) as setting of a pseudo base station. In addition, in a carrier aggregation test, the LTE interface unit 22 sets frequencies or output levels of a primary component carrier (primary CC, hereinafter also referred to as PCC) and a secondary component carrier (secondary CC, hereinafter also referred to as SCC).

The LTE interface unit 22 can acquire, for example, a configuration of the signal generation unit and a setting method of the signal generation unit as a hardware configuration of the LTE measurement unit 12. The configuration of the signal generation unit includes a configuration whether only a signal for one frequency can be generated, a configuration whether a signal for a plurality of frequencies are generated, or the like. The setting method of the signal generation unit includes a method whether only a signal for one frequency can be set, a method whether a signal for a plurality of frequencies are set, a method how can a plurality of frequencies be set when the signal of the plurality of frequencies are set, or the like.

The first signal generation unit 51a and the second signal generation unit 51b of the present embodiment can generate the signal for the plurality of frequencies. For example, when a signal having different two frequencies is generated, the first signal generation unit 51a and the second signal generation unit 51b set a center frequency (average value) of the two frequencies.

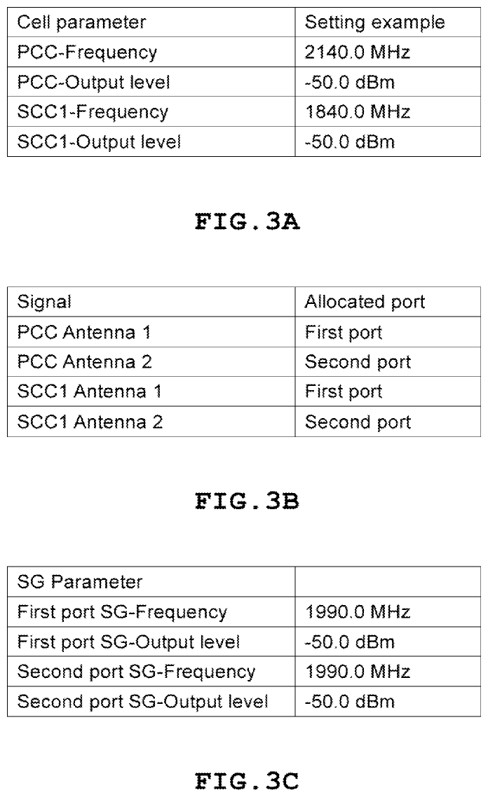

For example, the LTE interface unit 22 sets the setting of frequencies of PCC and SCC and an output level as shown in FIG. 3A.

As a result of acquiring the hardware configuration of the signal generation unit of the LTE measurement unit 12, when the setting method of the signal generation unit sets only the signal for one frequency, the LTE interface unit 22 sets a frequency of one signal generation unit to 2140.0 MHz and the output level thereof to −50.0 dBm, and sets the frequency of another signal generation unit to 1840.0 MHz and the output level thereof to −50.0 dBm.

As a result of acquiring the hardware configuration of the signal generation unit of the LTE measurement unit 12, the signal for the plurality of frequencies can be set and the center frequencies (average values) of two frequencies are set as in the first signal generation unit 51a and the second signal generation unit 51b in the present embodiment, the LTE interface unit 22 sets a frequency of 1990.0 MHz and an output level of −50.0 dBm to the first signal generation unit 51a.

For example, when the LTE interface unit 22 executes a test of 2×2 multi input multi output (MIMO) in the configuration of PCC and SCC in FIG. 3A, a signal of Antenna 1 of PCC is allocated to the first port 60a, a signal of Antenna 2 of PCC is allocated to the second port 60b, a signal of Antenna 1 of SCC is allocated to the first port 60a, and a signal of Antenna 2 of SCC is allocated to the second port 60b, as shown in FIG. 3B.

As shown in FIG. 3C, the LTE interface unit 22 sets the frequency of 1990.0 MHz and the output level of −50.0 dBm to the first signal generation unit 51a, and sets the frequency of 1990.0 MHz and the output level of −50.0 dBm to the second signal generation unit 51b.

As described above, in the present embodiment, the LTE interface unit 22 acquires the setting method of the signal generation unit of the LTE measurement unit 12, and converts and sets the parameter set in the interface with the user into the acquired setting method.

Therefore, even if the hardware configuration of the signal generation unit of the LTE measurement unit 12 changes, a test without changing the parameters in the interface with the user can be set, and an operation of switching devices can be reduced.

In the present embodiment, a configuration in which the mobile terminal testing device 1 is controlled from the PC 2 is shown, but the present embodiment is not limited thereto. Similarly, a configuration in which the mobile terminal testing device 1 is integrated with the PC 2 can be also implemented.

Although the embodiment of the present invention has been disclosed, it is apparent that those skilled in the art could have made changes without departing from the scope of this invention. It is intended that any and all such modifications and equivalents are involved in the appended claims.

### DESCRIPTION OF REFERENCE NUMERALS AND SIGNS

1 Mobile terminal testing device
2 Personal computer device (external device)
12 LTE measurement unit (measurement unit)
13 NR measurement unit (measurement unit)
22 LTE interface unit (interface unit)
23 NR interface unit (interface unit)
51a First signal generation unit (signal generation unit)
51b Second signal generation unit (signal generation unit)

What is claimed is:

1. A mobile terminal testing system comprising: a mobile terminal testing device that tests a mobile terminal by simulating a mobile communication base station; and an external device that executes a test by controlling the mobile terminal testing device,
wherein the external device includes an interface unit that controls an interface with a user for a predetermined communication standard,
the mobile terminal testing device includes a measurement unit that transmits and receives a signal to and from the mobile terminal according to the predetermined communication standard, and
the interface unit acquires a hardware configuration of the measurement unit, and converts and sets a parameter set in the interface with the user into a parameter suitable for the hardware configuration of the measurement unit.

2. The mobile terminal testing system according to claim 1,
wherein the measurement unit includes a signal generation unit that generates a predetermined signal, and
the interface unit converts and sets the parameter set in the interface with the user into the parameter suitable for the hardware configuration of the measurement unit, according to a parameter setting method of the signal generation unit.

3. The mobile terminal testing system according to claim 2,
wherein the signal generation unit enables generation of a signal for a plurality of frequencies, and
the parameter set in the interface with the user is a center frequency of the plurality of frequencies, and the parameter suitable for the hardware configuration of the measurement unit is the plurality of frequencies.

4. A parameter setting method of a mobile terminal testing system, in which the mobile terminal testing system includes a mobile terminal testing device that includes a measurement unit which transmits and receives a signal to and from a mobile terminal according to a predetermined communication standard to test the mobile terminal by simulating a mobile communication base station, and an external device that includes an interface unit which controls an interface with a user for the predetermined communication standard to execute a test by controlling the mobile terminal testing device, the parameter setting method comprising:
a step of acquiring a hardware configuration of the measurement unit; and
a step of converting and setting a parameter set in the interface with the user into a parameter suitable for the hardware configuration of the measurement unit.
